(19) United States
(12) Patent Application Publication
(10) Pub. No.: US 2012/0188146 A1
(43) Pub. Date: Jul. 26, 2012

(54) DISPLAY SCREEN SYSTEM AND COMPONENTS THEREOF

(76) Inventor: Jacobus Gidion van Zyl, Bellville (ZA)

(21) Appl. No.: 13/100,616

(22) Filed: May 4, 2011

(30) Foreign Application Priority Data
Jan. 24, 2011 (ZA) 2011/00586

(51) Int. Cl. G09G 5/12; G06F 15/16

(52) U.S. Cl. 345/2.1

(57) ABSTRACT

A display screen system is provided in which at least one, and generally multiple electronic display screens, each has a microcontroller with an associated electronic memory for retaining current data corresponding to information to be displayed on the display screen sequentially. A wireless communications device having a unique identification code is a part of each display screen assembly so that it can be uniquely accessed by a wireless communications device of a control station to receive data to be retained in the electronic memory for subsequent display on the display screen. The microcontroller is typically programmed to display information sequentially for predetermined periods of time with optional override facilities. The unique identification code may be a communications code or number associated with the device in a wireless communications network, typically a cell phone network. A camera may be included to develop data corresponding to a field of view of the camera for transmission to the control station. The control station is accessible to system members by way of a communications network such as the internet so that system members are enabled to secure display time on one or more display screens that are located in particular places.

### FIELD OF THE INVENTION

This invention relates to a display screen system and components thereof, and more particularly, to a display screen system in which multiple exterior display screens can be installed at required locations for communicating, typically with the public, any information or promotional material.

The display screen system may be used by local authorities for communicating information to the public in relation to events or prevailing traffic, weather or other conditions; it may be used by the media for promoting the sale of newspapers in the manner of a “newspaper placard”; it may be used by other commercial entities in order to promote products, services or events; or it may be used to convey any other information to a restricted audience or to sectors of the public at large.

Still more particularly, the invention relates to a display screen system and components thereof wherein any particular item of information or promotional material may be displayed for limited time periods in a succession of different items of information or promotional material.

### BACKGROUND TO THE INVENTION

Digital display screens made up of an array of “tiles” of multiple lights, at the present state of technological development LEDs [light emitting diodes] arranged on LED displays, that can be “tiled” to form larger screen areas, are becoming commonplace. They are used in a variety of different situations for promoting a series of different events, products or services of different entities, often commercial entities, in either indoor or outdoor applications.

They may also be used for the purpose of conveying information to interested parties or other groups of people such as the general public in outdoor applications including by a controlling authority such as a traffic authority that may use a series of information signs for communicating traffic, road or weather conditions to the public.

United States patent publication number US 2010/0109974 describes a system in which a single transmitter and CPU can be used to control multiple displays each of which can display a different image or video. The transmission of data takes place to all of the displays each of which recognizes, by way of unique identification header, only its targeted images or video, and rejects the rest of the data on the basis of unmatched identification data. A display's targeted data may be recorded and displayed until a replacement is received, or for a predetermined period of time. A large amount of data is thus sent to each display that is not used by that display but simply rejected.

Whilst this system may operate effectively in particular circumstances in which there is no restriction on the quantity of data that can be communicated between the single transmitter and multiple displays, such as in the instance that the multiple displays are hardwired to the transmitter either directly individually or in daisy chain relationship, the system is inapplicable, as far as applicant is aware, over long distances in which such a communication is either impractical or excessively costly, or both.

Another problem with many display screen systems is that they may be underutilized having regard to the capital cost of installation.

Also, in the light of the cost, many potential users of a display screen system of this general nature will not use them as the cost is prohibitive.

It is to be understood that the term system member as used in this specification is intended to mean a participant whether or not it is a member at any particular time during an exchange of information with a control station but that becomes a system member insofar as appropriate information concerning the relevant system member is recorded for management and control purposes. Being a system member may therefore involve any one transaction or a series of transactions over a period of time.

### OBJECT OF THE INVENTION

It is an object of this invention to provide a cost-effective display screen system that will facilitate use of multiple display screens controlled from a central control station wherein the display screen system and method of using it are more appropriate to use by many entities that would be individually unable to do so.

It is another object of the invention to provide a display screen system having user-friendly accessibility for receiving data to be displayed on behalf of multiple users of the system.

It is another object of the invention to provide a control unit for multiple display screens and a method of controlling multiple display screens remotely.

It is yet another object of the invention to provide a display screen assembly for use in a system and method according to the invention.

### SUMMARY OF THE INVENTION

In accordance with a first aspect of this invention there is provided a display screen system comprising at least one electronic display screen having a microcontroller with an associated electronic memory wherein the microcontroller controls data retained in the electronic memory corresponding to information to be displayed on the display screen sequentially, and a wireless communications device for receiving data to be retained in the electronic memory for subsequent display in the form of information on the display screen, and a control station having a control wireless communications device capable of communicating with the wireless communications device of the display screen to transmit data to the latter, the system being characterized in that at least the communications device associated with the display screen has a unique identification code whereby it can be uniquely accessed by the communications device of the control station.

Further features of the first aspect of the invention provide for the microcontroller to be programmed to display information sequentially for predetermined periods of time with optional override facilities; for the unique identification code of the communications device of the display screen to be a communications code or number associated with the device in a wireless communications network of which the communications device of the control station is also a component; for the wireless communications network to be a public communications network and especially, a public communications network such as a cell phone network preferably having the facility of transmitting data using a data channel in which instance data transmitted from the control station to a display screen is transmittable by way of the data channel; for the system to include multiple display screens each with their self-contained individual microcontroller having an associated memory and a communications device in which instance each of the unique identification codes is different and unique to the particular display screen; and for data transmitted to be formed into data packets such as SMS messages.

A still further feature of the first aspect of the invention provides for a display screen to have associated with it a camera that may be enabled to develop data corresponding to the field of view of the camera in which instance the microcontroller is enabled to transmit such data to the control station as and when required in a suitable format.

In accordance with a second aspect of the invention there is provided a control station for controlling the operation of at least one display screen of the general type defined above, the control station comprising a computer assembly and associated data base wherein the computer is accessible to system members by way of a communications network and multiple instructing communications devices are operable by system members to communicate with the control station and wherein the control station is enabled to provide information as to availability of any one or more display screens that are located in particular places that may be of interest to a system member for the purpose of displaying information on such display screen at the instance of the system member; the computer assembly having associated with it a communications device for transmitting data from the computer assembly to one or more uniquely identified remote display screens; wherein the computer assembly is enabled to exchange data with a system member by way of the communications network to identify one or more display screens on which information of the system member's choice is to be displayed and to receive data representing the information to be displayed and to transmit that data to the relevant display screen or screens.

Further features of this aspect of the invention provide for the communications network to be the Internet in which instance the instructing communications devices are typically computers of one type or another that may communicate by landline or wirelessly with an Internet service provider; for the computer to include a program that rejects information containing undesirable words or graphics or will only accept words from a predetermined list; and for the computer assembly to include a program that controls payment for the display of information on one or more display screens in terms of an agreed schedule in which instance the communications device associated with the control station is only enabled to transmit data representing information to be displayed once a satisfactory payment situation has been established.

In accordance with a third aspect of this invention there is provided a method of controlling a display screen system including multiple display screens of the type indicated above wherein a control unit interacts with multiple system members by way of a communications network whereby system members are able to determine the availability of display screens located at places chosen by a system member from available places as posted on a website managed by the control unit; the method being characterized in that it includes the steps of making available information as to the location of multiple display screens to enable a system member to choose one or more display screens, interacting with a system member to establish the identity of one or more display screens that the system member wishes to utilize and that has available display slots; issuing information as to payment required for utilization of display slots; receiving the information to be displayed; processing that information to ensure it conforms with predetermined standards; and transmitting at least one data packet to at least one display screen to enable the display screen to receive it and display it sequentially with others.

Whilst a display system according to the invention could be employed in many different applications, it is presently envisage that a prime target market is public places such as roadways and pedestrian routes in which instance display screens are supported at selected locations and are conveniently supported either on their own posts or, more preferably, on the street or municipal streetlamp posts. In such an instance, any cameras associated with the display screens can be used for security purposes for monitoring activities in the relevant locality and the display screens can be employed by newspaper production companies to carry their billboard headings. Such an installation of display screens can also be used by local authorities, especially traffic authorities for the purpose of advising motorists of prevailing conditions in particular regions of a roadway and especially as to traffic jams that may exist for any one of a variety of different reasons such as a traffic accident. Such display screens can be used for multiple other purposes as is well known in the art.

In order that the above and other features of the invention may be more fully understood, one embodiment of display screen system according to the invention will now be described with reference to the accompanying drawings.

### BRIEF DESCRIPTION OF THE DRAWINGS

In the drawings:—

FIG. 1 is a schematic elevation of a lamp post supporting a display screen according to the invention;

FIG. 2 is a schematic side elevation of the lamp post illustrated in FIG. 1; and,

FIG. 3 is schematic illustration of the components of one embodiment of display screen system according to the invention.

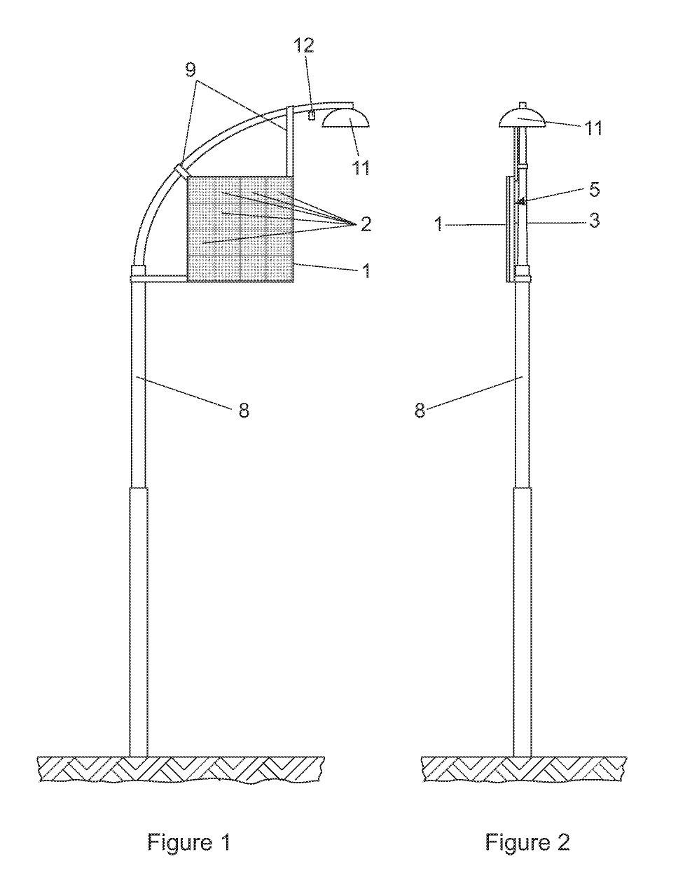

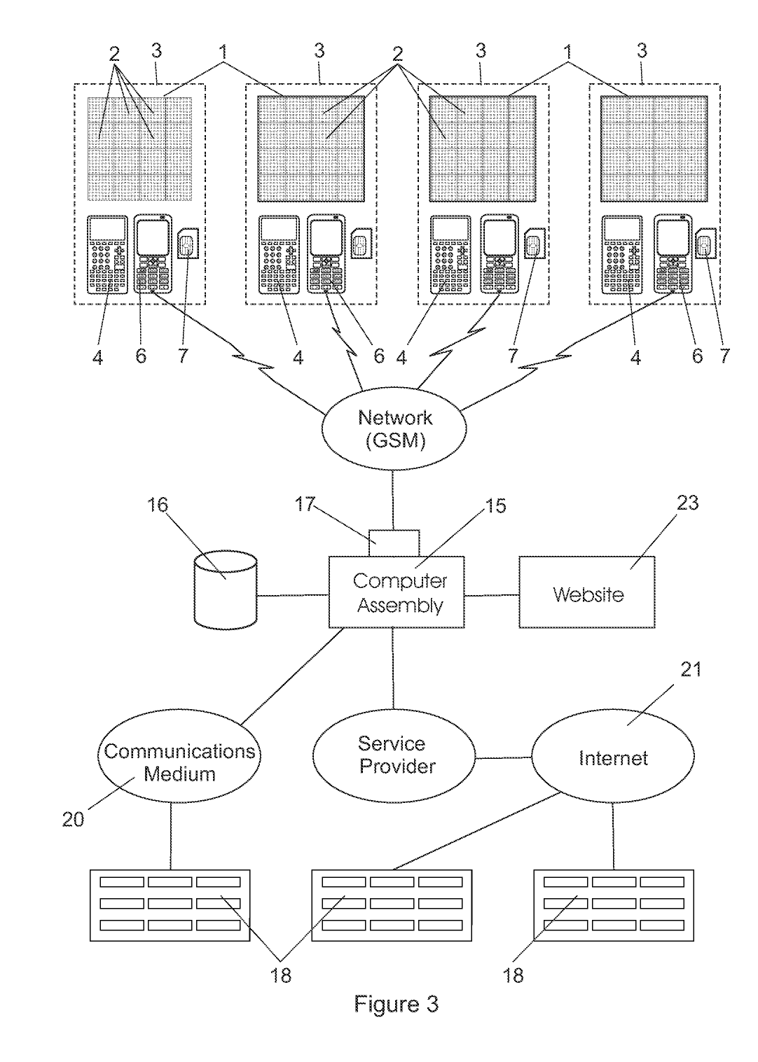

### DETAILED DESCRIPTION WITH REFERENCE TO THE DRAWINGS

In the embodiment of the invention illustrated in the drawings, a display screen system comprises a series of electronic display screens [1] each made up of multiple “tiles” or LED displays [2] each of which comprises multiple LEDs mounted on a printed circuit [PC] board in well-known manner. The tiles are fitted to a supporting base [3] and the LEDs are arranged to be energized by a microcontroller [4] having an associated electronic memory [not illustrated separately] wherein the microcontroller controls the switching of the LEDs in accordance with data retained in the electronic memory corresponding to information to be displayed on the display screen.

The information is typically displayed sequentially with other items of information with the microcontroller being programmed to display information sequentially for predetermined periods of time with optional override facilities in the event that the display screens are needed for conveying information to the public. The microprocessor may automatically determine the number of total messages and display them sequentially throughout any chosen time period such as a day for generally equal periods of time, typically of the order of 5 to 30 seconds.

The individual “tiles” could have any commercially available size such as 160×160 millimeters or 200×200 millimeters or any other available size. Each tile typically has a jack or socket mounted on it to be connected to the control circuitry. A display panel of the required size is simply made up by the modular assembly of the required number of tiles. One suitable size is considered to be slightly larger than conventional newspaper placards of the type ordinarily attached to lamp posts in order to promote the sale of newspapers. It is to be noted that the rear [5] of each display unit will also be available as a base for receiving hard copy advertisements. They display screen could be either full color or a black-and-white screen.

Each display screen is also fitted with a wireless communications device [6] for receiving data by way of a public communications network wherein the data is to be retained in the electronic memory for display in the form of information on the display screen in its sequential turn as determined by the programming of the microprocessor. The wireless communications device may assume any form but is, in this instance, of the general nature of a cellular telephone having a unique identification module in the form of a SIM (Subscriber Identity Module) card [7] that has a unique identifying code in the form of a telephone number within the mobile telephone system of a cell phone operator. It is preferred, in this application, that the SIM card has a very long phone number to prevent accidental “wrong number” type of communications being made with the communications device. In any event, the public communications network preferably has a facility of transmitting data using a data channel in which instance data transmitted to a display screen may be transmitted in the form of data packets such as SMS (Short Message Service) or MMS (Multimedia Message Service) messages.

In this particular embodiment of the invention the display screens are intended mainly for roadside applications in order to serve the motorist market and it is intended that the display screens be mounted on municipal lamp posts [8] next to the road. In such an instance a motorist should be able to see the letters displayed on a display screen from a distance of about 50 meters with the display screen being positioned approximately directly in the line of driving for ease of visibility. One or more brackets [9] may be used to secure the display screen in its elevated position. Of course, the display screen system could be used in any other target market that could be mounted on any other suitable supports such as buildings or other structures.

In this application, electrical energy for operating the electronics of a display screen would preferably be the electricity supply to a streetlamp [11] carried by the post. In such an instance, an entire block of streetlamps would need to be fitted with individual photo switches [12] so that the electricity can be left on during the daytime [which it is not done at present because of the block switching of multiple streetlamps] and the streetlamps would then only become illuminated below a predetermined light intensity that would be dependent on the photo switch itself.

It is envisaged that an entire display screen system will include numerous individual display screens as described above and that all of them would be located at different geographic locations whilst being controlled by a central control station including a computer assembly [15] having a data base [16] and a wireless control communications device [17] capable of communicating with the communication devices of the display screens to transmit data to the latter by way of the public communications network. Of course, each of the individual display screens can be accessed independently of the others using the unique identification code or telephone number of the relevant communications device.

The control station is accessible to system members or potential system members using appropriate instructing communications devices [18] that are typically computers of one type or another that may communicate by landline or wirelessly with an Internet service provider by way of any suitable communications medium [20] but more especially, by way of the Internet [21].

For the latter purpose in particular, the control station has associated with it a website [23] that is enabled to make information available to system members, or entities wishing to become system members. Such information includes the location of each of the display screens and the availability in the form of time slots of any one or more of them at particular times and days of interest to a system member. The control station is thus enabled to exchange data with a system member by way of the communications network to identify one or more display screens on which information of the system member's choice is to be displayed and to receive data representing the information to be displayed.

The data received is processed by the computer assembly especially for the purpose of censoring it to prevent undesirable material from being displayed on a display screen and, for this purpose, the computer assembly preferably has a suitable profanity prevention program. Once the data has been processed suitably, the computer assembly manages the data and, at an appropriate time, transmits that data to the relevant display screen or screens.

The website is constructed in the usual way that facilitates making different options available to a system member and preferably manages all the display screens situated anywhere in a geographic area and even countrywide.

Every unregistered system member will be asked to register and fill out a registration form online. This is generally necessary for legal and administrative purposes.

Depending on the capabilities of the display screen and associated microcontroller, there may be a restriction on the use of certain fonts and letter sizes. In a simpler form of the invention, the display screens will usually have a limited animation capability.

In a cost effective environment, a display screen may have a relative low display resolution and may be more information focused by screening scripting phrases or lines in the general manner of newspaper placards.

Advertisers can also advertise by screening small logo's in the corners of the units or as default screensavers where a time slot is not in use.

The programming of the computer assembly also includes a payment program that delays onward transmission of the data corresponding to a required display until such time as payment has been received.

It is envisaged that the system will be highly useful for the relevant municipality or district administration who will, in exchange for allowing use of their lampposts, be entitled to free messages for communicating with the general public, motivational logos and other information including warnings and emergency information.

Any person may access and use an information system such as this as long as they honour the rules of which they will be informed during the registration procedure and by accepting the agreements they will be allowed to screen whatever they require.

As an added feature, each display screen may be provided with a tampering detector which will, upon activation, send a message such as an SMS or MMS to the control station to advise of a tampering attempt of a specific unit and its location.

Also, the display screen may include a camera that may be used by security authorities and the system may be arranged so that such an authority can open up a link to any camera through the internet and view whatever the specific camera can see or record in the area for a particular period etc. Such a viewing session may be paid for upfront and the viewing endure for so long as the bandwith that was purchased lasts.

It will be understood that numerous variations of the display screen system described above are possible without departing from the scope hereof.

1. A display screen system comprising at least one electronic display screen having a microcontroller with an associated electronic memory wherein the microcontroller controls data retained in the electronic memory corresponding to information to be displayed on the display screen sequentially, and a wireless communications device for receiving data to be retained in the electronic memory for subsequent display in the form of information on the display screen, and a control station having a control wireless communications device capable of communicating with the wireless communications device of the display screen to transmit data to the latter, wherein at least the communications device associated with the display screen has a unique identification code whereby it can be uniquely accessed by the communications device of the control station.

2. A display screen system as claimed in claim 1 in which the microcontroller is programmed to display information sequentially for predetermined periods of time with optional override facilities.

3. A display screen system as claimed in claim 1 in which the unique identification code of the communications device of the display screen is a communications code or number associated with the device in a wireless communications network of which the communications device of the control station is also a component.

4. A display screen system as claimed in claim 3 in which the wireless communications network is a public communications network.

5. A display screen system as claimed in claim 4 in which the public communications network is a cell phone network having the facility of transmitting data using a data channel in which instance data transmitted from the control station to a display screen is transmittable by way of the data channel.

6. A display screen system as claimed in claim 5 in which data transmitted is formed into data packets

7. A display screen system as claimed in claim 1 in which the system includes multiple display screens each with their self-contained individual microcontroller having an associated memory and a communications device in which instance each of the unique identification codes is different and unique to the particular display screen.

8. A display screen system as claimed in claim 1 in which a display screen has associated with it a camera that may be enabled to develop data corresponding to the field of view of the camera in which instance the microcontroller is enabled to transmit such data to the control station as and when required in a suitable format

9. A control station for controlling the operation of at least one display screen of a system as claimed in any one of the preceding claims, the control station comprising a computer assembly and associated data base, wherein the computer is accessible to system members by way of a communications network and multiple instructing communications devices are operable by system members to communicate with the control station and wherein the control station is enabled to provide information as to availability of any one or more display screens that are located in particular places that may be of interest to a system member for the purpose of displaying information on such display screen at the instance of the system member; the computer assembly having associated with it a communications device for transmitting data from the computer assembly to one or more uniquely identified remote display screens; wherein the computer assembly is enabled to exchange data with a system member by way of the communications network to identify one or more display screens on which information of the system member's choice is to be displayed and to receive data representing the information to be displayed and to transmit that data to the relevant display screen or screens.

10. A control station as claimed in claim 9 in which the communications network whereby a system member may communicate with the control station is the Internet.

11. A control station as claimed in claim 9 in which the computer includes a program that rejects information containing undesirable words or graphics or will only accept words from a predetermined list.

12. A control station as claimed in claim 9 in which the computer assembly includes a program that controls payment for the display of information on one or more display screens in terms of a schedule in which instance the communications device associated with the control station is only enabled to transmit data representing information to be displayed once a satisfactory payment situation has been established.

13. A display screen comprising a microcontroller with an associated electronic memory wherein the microcontroller controls data retained in the electronic memory corresponding to information to be displayed on the display screen sequentially, and a wireless communications device for receiving data to be retained in the electronic memory for subsequent display in the form of information on the display screen, the wireless communications device being capable of receiving data from a control station having a control wireless communications device capable of communicating with the wireless communications device of the display screen to transmit data to the latter, wherein the communications device associated with the display screen has a unique identification code whereby it can be uniquely accessed by the communications device of the control station.

14. A method of controlling a display screen system including multiple display screens wherein a control unit interacts with multiple system members by way of a communications network whereby system members are able to determine the availability of display screens located at places chosen by a system member from available places as posted on a website managed by the control unit; the method including the steps of making available information as to the location of multiple display screens to enable a system member to choose one or more display screens, interacting with a system member to establish the identity of one or more display screens that the system member wishes to utilize and that has available display slots; issuing information as to payment required for utilization of display slots; receiving the information to be displayed; processing that information to ensure it conforms with predetermined standards; and transmitting at least one data packet to at least one display screen to enable the display screen to receive it and display it sequentially with others.
